(19) United States
(12) Patent Application Publication
(10) Pub. No.: US 2003/0056035 A1
(43) Pub. Date: Mar. 20, 2003

(54) Graphics controller for high speed transmission of memory write commands

(76) Inventors: Barinder Singh Rai, Surrey (CA); George Henry Lyons, Langley (CA)

Correspondence Address: EPSON RESEARCH AND DEVELOPMENT INC, INTELLECTUAL PROPERTY DEPT, 150 RIVER OAKS PARKWAY, SUITE 225, SAN JOSE, CA, 95134, US

(21) Appl. No.: 10/131,644

(22) Filed: Apr. 24, 2002

Related U.S. Application Data
(60) Provisional application No. 60/323,513, filed on Sep. 18, 2001.

(51) Int. Cl. G06F 3/00

(52) U.S. Cl. 710/5

(57) ABSTRACT

A graphics controller for high speed transmission for memory write commands. A memory controller chip includes a logic circuit coupled to a first memory and a second memory. The logic circuit is adapted to respond to a first issued command from a CPU by causing the memory controller chip to store the first command in the first memory and to begin processing the first command. If the CPU issues a second command during the time that the memory controller chip is processing the first command, the logic circuit responds by causing the memory controller chip to store the second command in the second memory.

### CONTINUING APPLICATION DATA

This application claims the benefit of U.S. Provisional Application No. 60/323,513 filed Sep. 18, 2001 under 35 U.S.C. §119(e).

### FIELD OF THE INVENTION

The present invention relates to a method and apparatus for transferring data between a computer's central processing unit (“CPU”) and an off-chip graphics controller. More particularly, the present invention is directed to a graphics controller with a read/write state machine for accepting high speed transmission of memory write commands initiated by the CPU.

### BACKGROUND OF THE INVENTION

A common practice in the art of computer architecture is to move frequently performed, computationally intensive operations from the CPU to a special purpose functional unit, such as a graphics controller. The graphics controller is typically a separate integrated circuit (“chip”). In a computer system with a graphics controller chip, the graphics controller handles various tasks associated with displaying images on a display (such as converting primitive data to pixels), freeing the CPU to perform other tasks. Moving graphics operations from the CPU to the graphics controller improves the performance of the computer system. In practice, however, the amount of improvement is generally not as great as expected. The reason is that the transfer of data between the CPU and the graphics controller becomes a bottleneck that places a limit on the amount of improvement that can be realized. To illustrate the effect of the data transfer bottleneck, consider that in a typical computer system the CPU theoretically requires only 2 bus clock cycles (“BCLKs”) to perform a memory write command and 4 BCLKs to perform a memory read command. In practice, however, writing to a prior art graphics controller requires 5 BCLKs and reading requires up to 8 BCLKs. During the 3-4 additional BCLKs that are required with a prior art graphics controller, the CPU does not perform any useful work.

The transfer of data between a CPU and a graphics controller involves a number of steps. These steps must be coordinated so that data is not transferred to the graphics controller faster than it can accept it and so that the CPU knows when the data it has requested is available. To regulate the flow of data from the CPU to the graphics controller, the graphics controller includes a read/write control circuit that can be defined as a read/write state machine.

The read/write state machine typically has four states: An “idle” state in which the graphics controller waits for a command from the CPU; a “pause” state in which the read/write state machine checks whether the graphics controller is ready to process the command; a “request” state in which the graphics controller begins processing the command; and, an “end” state in which the graphics controller finishes processing the command. The read/write state machine transitions from state to state in a fixed sequence for each memory cycle. When the read/write state machine receives a command, it transitions sequentially from the idle state to the pause state to the request state to the end state. From the end state, the read/write state machine returns to the idle state where it waits for the next command. While the read/write state machine may remain in a state for one clock period or longer, depending on the type and sequence of commands, the state transition sequence does not change.

The bottleneck problem becomes apparent when the CPU issues a series of consecutive commands for memory write cycles. The problem occurs, in part, because it takes the graphics controller longer to process a command than it takes the CPU to send a subsequent command. Because the CPU does not perform any useful work while it is waiting for the graphics controller to accept another command, the prior art read/write state machine degrades the overall performance of the computer system.

Accordingly, there is a need for a graphics controller chip that is capable of accepting high speed transmission of memory write commands initiated by a CPU.

### BRIEF SUMMARY OF THE INVENTION

The invention disclosed herein is a graphics controller for high speed transmission for memory write commands. Within the scope of the invention, there is a memory controller chip for use with an off-chip CPU issuing a plurality of commands. The memory controller chip preferably comprises a logic circuit coupled to a first memory and a second memory. The logic circuit is adapted to respond to a first issued command from a CPU by causing the memory controller chip to store the first command in the first memory and to begin processing the first command. If the CPU issues a second command during the time that the memory controller chip is processing the first command, the logic circuit responds by causing the memory controller chip to store the second command in the second memory.

The foregoing and other objectives, features, and advantages of the invention will be more readily understood upon consideration of the following detailed description of the invention, taken in conjunction with the accompanying drawings.

### BRIEF DESCRIPTION OF THE SEVERAL VIEWS OF THE DRAWING

FIG. 1 is a block diagram illustrating an exemplary prior art computer system including a CPU, a display, and a graphics controller.

FIG. 2 is a block diagram illustrating functional blocks, including a read/write controller, within the graphics controller of FIG. 1.

FIG. 3 is a block diagram illustrating functional blocks, including a read/write state machine, within the read/write controller of FIG. 2.

FIG. 4 is a state transition diagram for the read/write state machine of FIG. 3.

FIG. 5 is a timing diagram illustrating memory write cycles of the computer system of FIG. 1.

FIG. 6 is a block diagram illustrating a read/write controller, including a read/write state machine, within a graphics controller according to the present invention.

FIG. 7 is a state transition diagram for a first embodiment of the read/write state machine of FIG. 6.

FIG. 8 is a timing diagram illustrating memory write cycles of a computer system that includes the graphics controller of FIG. 6.

FIG. 9 is a state transition diagram for a second embodiment of the read/write state machine of FIG. 6.

### DETAILED DESCRIPTION OF THE INVENTION

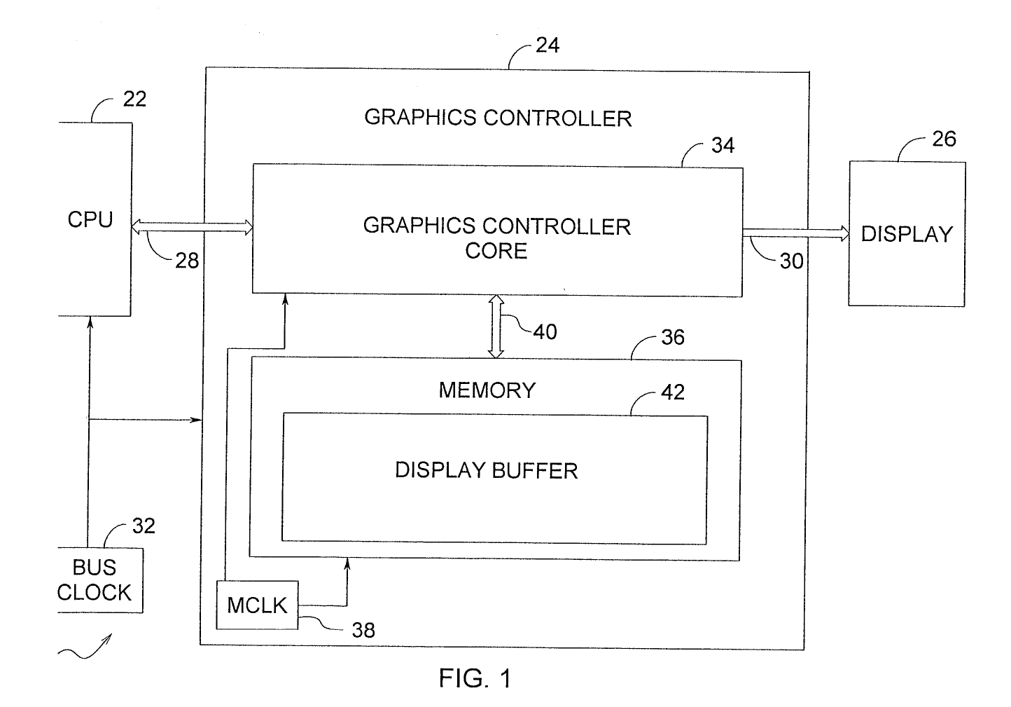

FIG. 1 illustrates a prior art computer system 20 including a graphics controller 24, a CPU 22, and a display 26. The computer system 20 illustrates a preferred context for the present invention; however, other contexts for the invention are contemplated, but this is not essential. As mentioned, the CPU and the graphics controller are typically separate chips. In addition, memory controllers of types other than the graphics controller 24 are contemplated.

The graphics controller 24 is coupled to the CPU 22 by a system bus 28. The graphics controller 24 is coupled to the display 26 by a display bus 30. To synchronize memory cycles between the CPU 22 and the graphics controller 24, a bus clock 32 is coupled to the CPU 22 and to the graphics controller 24. A graphics controller core 34, a memory 36, and memory clock (“MCLK”) 38 are included within the graphics controller 24. The graphics controller core 34 is coupled to the memory 36 by a memory bus 40. The memory clock 38 is coupled to the memory 36 and to the graphics controller core 34. The memory 36 includes the shown display buffer 42, but may also contain other types of data, such as audio or video data.

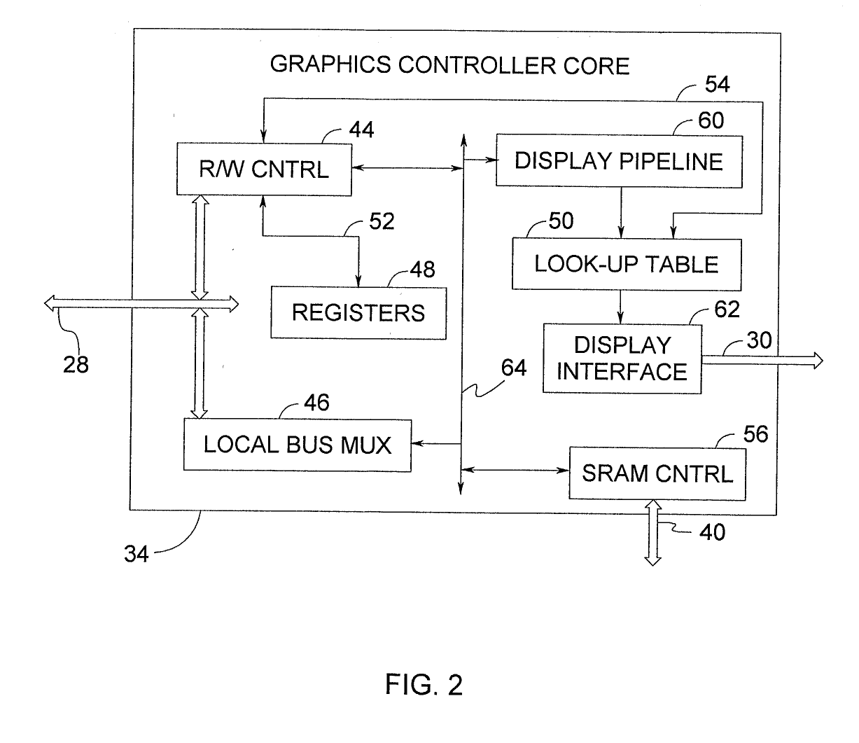

FIG. 2 illustrates some of the functional blocks included within the graphics controller core 34: a read/write controller (“R/W CNTRL”) 44, a local bus multiplexer (“local bus mux”) 46, a set of registers 48, a look-up table 50, an SRAM controller (“SRAM CNTRL”) 56, a display pipeline 60, and a display interface 62. The read/write controller 44 is coupled to the registers 48 via a register bus 52 and to the look-up table 50 via a look-up table bus 54. The read/write controller 44, the SRAM controller 56, the local bus mux 46, and the display pipeline 60 are coupled to each other via a graphics controller core bus 64. Both the read/write controller 44 and the local bus mux 46 are coupled to the system bus 28. The SRAM controller 56 is coupled to the memory 36 via the memory bus 40. The display interface 62 is coupled to the display 28 via the display bus 30. The registers 48 store configuration and other information. The look-up table 50 stores information needed for pixel processing. The SRAM controller 56 provides access and management functions for the memory 36.

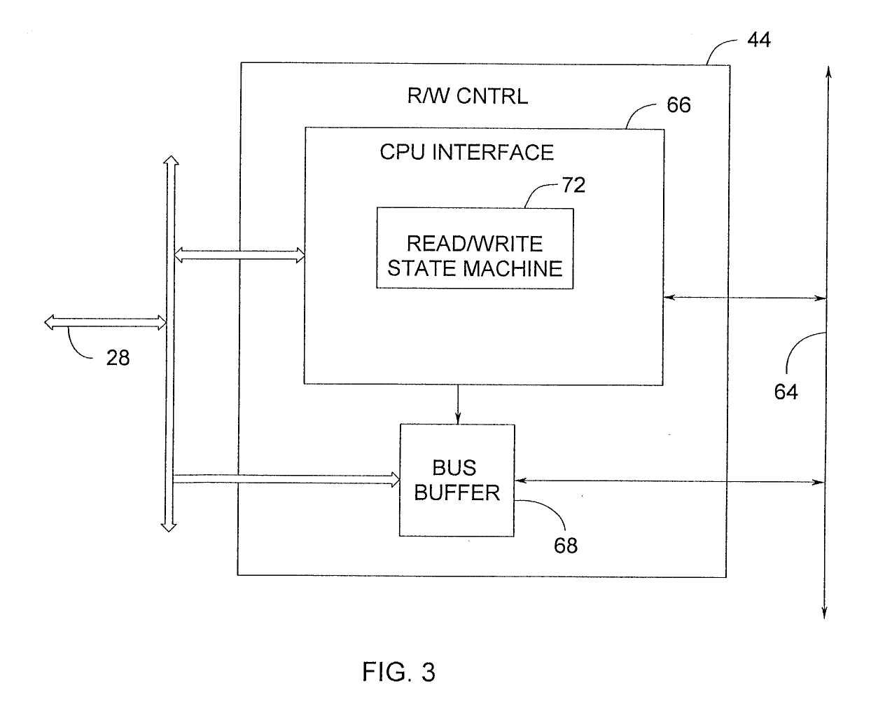

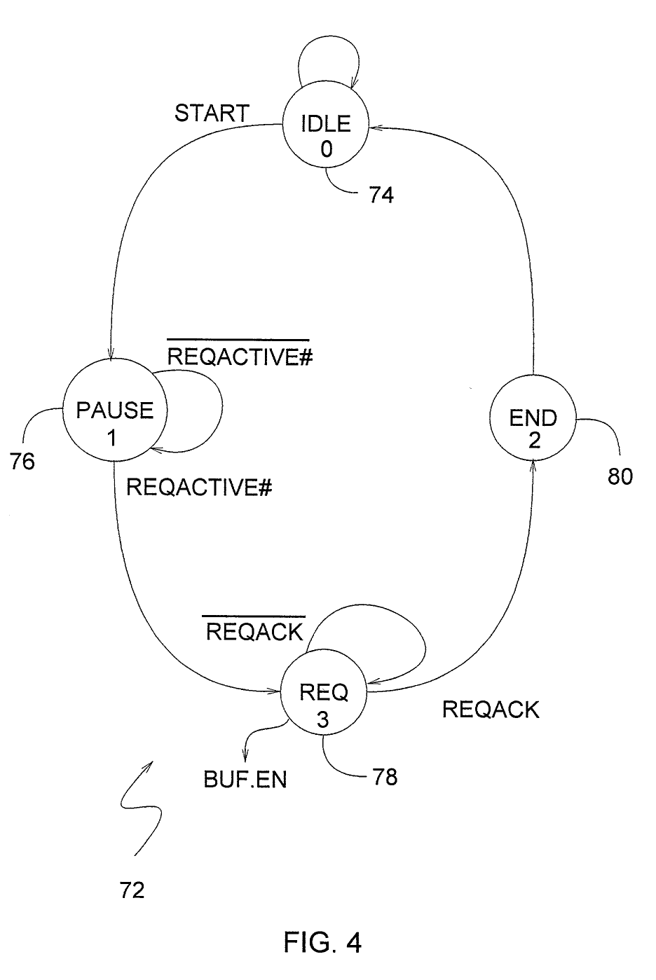

FIG. 3 is a block diagram illustrating functional blocks within the read/write controller 44 of FIG. 2. The read/write controller 44 includes a CPU interface 66 and a bus buffer 68. In addition, the CPU interface 66 includes a prior art read/write state machine 72. The CPU interface 66 monitors and places signals on the system bus 28. When the CPU issues a command, if the graphics controller 24 is ready to accept the command, the control, address, and data signals associated with the command are stored in the bus buffer 68. The graphics controller 24 processes the command using the command information stored in the bus buffer 68. If the CPU 22 issues a write command, the memory write data is copied from the bus buffer 68 and stored in the specified location. If the CPU 22 issues a read command, the requested memory read data is copied from the specified location and stored in the local bus mux 46. The CPU 22 then obtains the requested memory read data by sampling the local bus mux 46 via the system bus 28. The read/write state machine 72 is typically implemented as a logic circuit. FIG. 4 provides a state transition diagram for the read/write state machine 72. In FIG. 4, each bubble represents a state. The state and allowed transitions from one state to another are described below.

### State 0—IDLE

In the state IDLE 74, the read/write state machine 72 waits to receive a start signal (START). The IDLE 74 state is the initial state after start-up for the read/write state machine 72. When the CPU 22 asserts byte enable (BE) and chip select (CS#) signals, the CPU interface 66 decodes the signals to create the START signal to indicate that a memory cycle is requested and a command has therefore 10 issued. When the read/write state machine 72 detects the START signal, a wait signal (WAIT#) is asserted and the read/write state machine 72 transitions to a state PAUSE 76. The WAIT# signal tells the CPU 22 that the graphics controller 24 is busy. The WAIT# signal prevents the CPU 22 from issuing another command and causes the CPU 22 to begin inserting wait states.

### State 1—PAUSE

In the state PAUSE 76, the read/write state machine 72 checks to see whether the graphics controller 24 is ready to process another command. If a signal REQACTIVE# is asserted low, the graphics controller 24 has not yet finished processing a previous command and the read/write state machine 72 remains in the state PAUSE 76. On the other hand, if the signal REQACTIVE# is not asserted, the graphics controller 24 has finished processing the previous command and the read/write state machine 72 transitions to a state REQUEST 78.

### State 3—REQUEST

In the state REQUEST 78, the read/write state machine 72 stores control, 25 address, and data signals into the bus buffer 68 by asserting a buffer enable signal (BUF.EN). In the state REQUEST 78, the read/write state machine 72 generates the appropriate internal signals needed to process the command and monitors a signal REQACK. The signal REQACK indicates that the memory cycle is almost complete. If the command is for a write cycle or a register read cycle, the signal WAIT# is de-asserted when the REQACK signal is detected. In addition, detection of the signal REQACK causes the read/write state machine 72 transitions to a state END 80.

### State 2-END

In the state END 80, the signal WAIT# is removed if the command is for a 35 memory read cycle. In addition, other internal functions are performed during the state END 80. On the next BCLK, the read/write state machine 72 transitions from the state END 80 to the state IDLE 74.

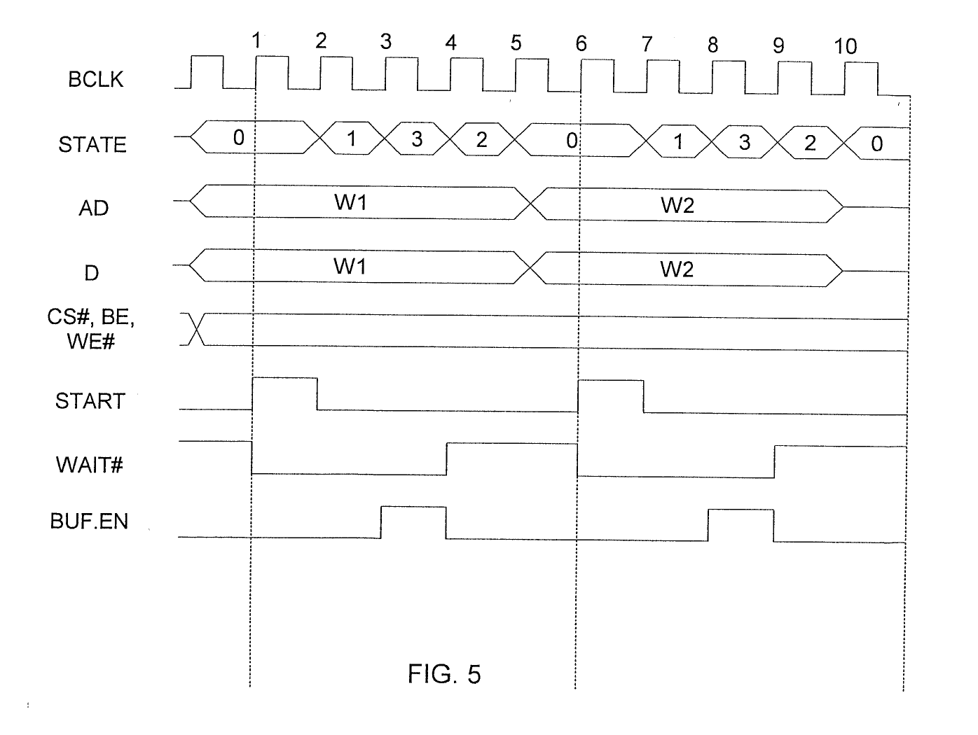

FIG. 5 shows a timing diagram illustrating exemplary write cycles of the computer system 20. The timing diagram shows the signal produced by the bus clock 32, the state of the read/write state machine 72, and various signals described below. As shown in FIG. 5, a first memory write cycle (W1) is initiated when the CPU 22 issues a command by placing an address signal (AD) and a data signal (D) on the system bus 28, and additionally asserting a chip select signal (CS#), a byte enable signal (BE), and a write enable signal (WE#). The signals CS# and BE are decoded to assert the WAIT# and START signals. In BCLK 3, the address, data, and control signals are stored in the bus buffer 68 and the WAIT# signal is de-asserted. The first command is completed during BCLK 5. A second memory write cycle begins in BCLK 6 and completes in BCLK 10. As FIG. 5 shows, a disadvantage of read/write state machine 72 is that 5 BCLKS must elapse after the CPU 22 has issued a command before the graphics controller 24 can accept a subsequent command from the CPU 22. In each write cycle, the CPU 22 is required to insert 3 wait states.

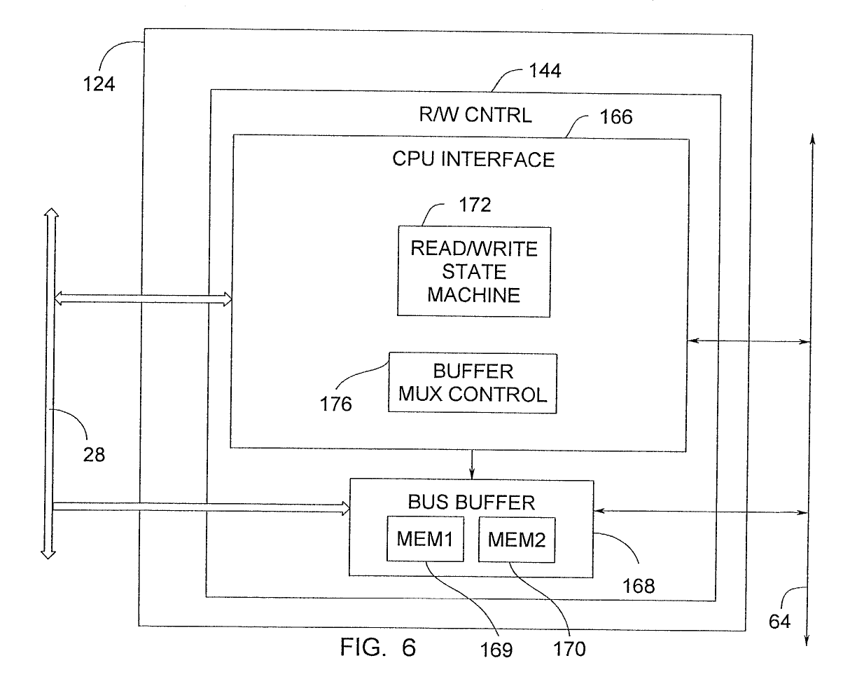

Having described a prior art computer system 20, a graphics controller 124 according to the present invention for use in the computer system 20 is next described. Turning to FIG. 6, the graphics controller 124 includes a read/write controller 144. The read/write controller 144 includes a CPU interface 166 and a bus buffer 168. The CPU interface 166 includes a read/write state machine 172, and a buffer multiplexer controller (“buffer mux control”) 176. The bus buffer 168 stores control, address, and data signals presented on the system bus 28 when the CPU 22 issues a command. The bus buffer 168 is preferably capable of storing two commands. In the shown embodiment, the bus buffer 168 includes a first memory (“MEM1”) 169 and a second memory (“MEM2”) 170. The graphics controller 124 uses the control, address, and data signals stored in the bus buffer 168 to process the memory write command. The buffer mux controller 176 selects either the first memory 169 or the second memory 170 for processing. Components within the graphics controller 124 assert internal status signals that indicate whether a memory write command is being processed or is complete. The read/write state machine 172 monitors these signals and determines whether a particular status signal corresponds to the memory write command stored in the first memory 169 or in the second memory 170.

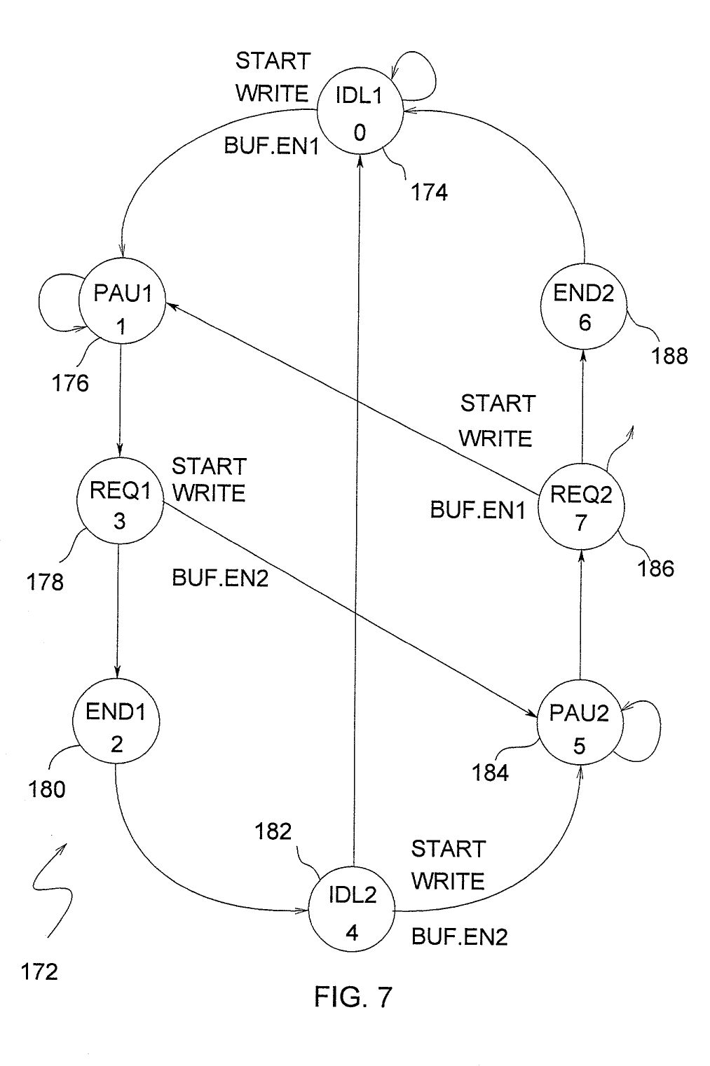

FIG. 7 shows an exemplary read/write state machine 172 according to the present invention. The shown state machine 172 has two idle states (IDL1, IDL2), two pause states (PAU1, PAU2), two request states (REQ1, REQ2), and two end states (END1, END2). The names for the states and signals are exemplary.

### State 0—IDL1

In a state IDL1 174, the read/write state machine 172 waits to receive the start signal (START). The IDL1 174 state is the initial state after start-up for the read/write state machine 172. When the read/write state machine 172 detects the START signal, the wait signal (WAIT#) is asserted. If the command is for a write to the memory 36, the registers 48, or the look-up table 50, the read/write state machine 172 stores control, address, and data signals into the bus buffer 168 by 10 asserting a first buffer enable signal (BUF.EN1). In one preferred embodiment, the control, address, and data signals are stored in the first memory 169. After the read/write state machine 172 detects the START signal, the read/write state machine 172 transitions to a state PAU1 176.

### State 1—PAUL

In the state PAU1 176, the read/write state machine 172 checks to see whether the graphics controller 124 is ready to process another command. If a signal REQACTIVE1# is asserted low, the graphics controller 124 has not yet finished processing a previous command and the read/write state machine 172 remains in the state PAU1 176. On the other hand, if the signal REQACTIVE1# is not asserted, the graphics controller 124 has finished processing the previous command and the read/write state machine 172 transitions to a state REQ1 178.

### State 3—REQ1

In the state REQ1 178, the read/write state machine 172 generates the appropriate internal signals needed to process the command and monitors a signal REQACK1 and the signal START. If the signal REQACK1 is asserted, the read/write state machine 172 transitions to a state END1 180. In addition, if REQACK1 is asserted, and if the START signal is asserted for a command that is for a write to the memory 36, the registers 48, or the look-up table 50, the read/write state machine 172 asserts a second buffer enable signal (BUF.EN2) and transitions to a state tPAU2 184. The signal BUF.EN2 causes control, address, and data signals to be stored into the bus buffer 168. In one preferred embodiment, control, address, and data signals are stored in the second memory 170.

### State 2—END1

In the state END1 180, internal functions are performed. On the next BCLK, the read/write state machine 172 transitions from the state END1 180 to a state IDL2 182.

### State 4—IDL2

In the state IDL2 182, the read/write state machine 172 waits to receive the signal START. If the signal START is detected for a command that is for a write to the memory 36, the registers 48, or the look-up table 50, the read/write state machine 172, the read/write state machine 172 transitions to a state PAU2 184 and the signal WAIT# is asserted. In addition, the read/write state machine 172 asserts a second buffer enable signal (BUF.EN2) to cause control, address, and data signals into the bus buffer 168. Otherwise, the read/write state machine 172 transitions to the state IDL1 174 on the next BCLK.

### State 5—PAU2

In the state PAU2 184, the read/write state machine 172 checks to see whether the graphics controller 124 is ready to process another command. If a signal REQACTIVE2# is asserted low, the graphics controller 124 has not yet finished processing a previous command and the read/write state machine 172 remains in the state PAU2 184. On the other hand, if the signal REQACTIVE2# is not asserted, the graphics controller 124 has finished processing the previous command and the read/write state machine 172 transitions to a state REQ2 186.

### State 7—REQ2

In the state REQ1 178, the read/write state machine 172 generates the appropriate internal signals needed to process the command and monitors a signal REQACK2 and the signal START. If the signal REQACK2 is asserted, the read/write state machine 172 transitions to a state END2 188. In addition, if REQACK2 is asserted, and if the START signal is asserted for a command that is for a write to the memory 36, the registers 48, or the look-up table 50, the read/write state machine 172 asserts the signal BUF.EN1 and transitions to a state PAU2 184.

### State 6—END2

In the state END2 188, internal functions are performed. On the next BCLK, the read/write state machine 172 transitions from the state END2 188 to the state IDL1 174.

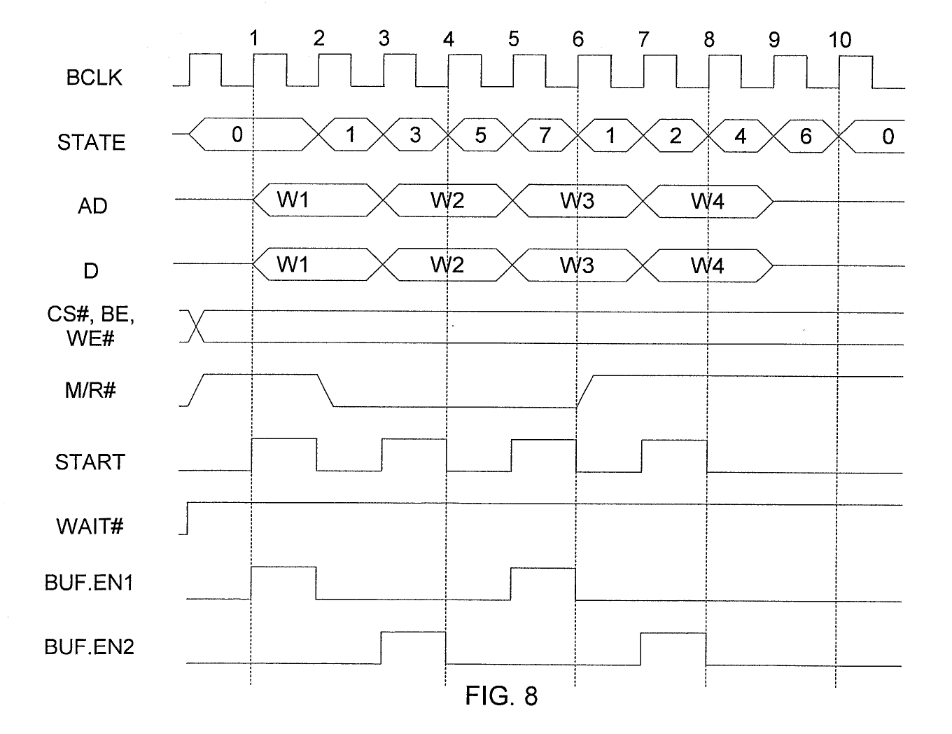

FIG. 8 shows a timing diagram for an exemplary write cycle in the computer system 20 that includes the graphics controller 124 according to the present invention. The timing diagram shows four consecutive memory write cycles: (1) a memory write cycle to the memory 36, (2) a memory write cycle to the registers 48, (3) a memory write cycle to the look-up table 50, and (4) a memory write cycle to the memory 36. The timing diagram shows the signal produced by the bus clock 32, the state of the read/write state machine 172, and various signals.

As shown in FIG. 8, a first memory write cycle (WI) is initiated when the CPU 22 issues a command by placing an address signal (AD) and a data signal (D) on the system bus 28, and additionally asserting the chip select signal (CS#), the write enable signal (WE#), and the byte enable signal (BE). The CS# and BE signals are decoded to assert the WAIT# and START signals. Before BCLK 1, however, the read/write state machine 172 causes the WAIT# signal to be de-asserted. In BCLK 1, the first buffer enable signal (BUF.EN1) is asserted and the signals associated with the first issued command are stored into the first memory 169 on the falling edge of the signal BUF.EN1. In BCLK 2, the CPU 22 issues a second command. In BCLK 3, address, data, and control signals for a second memory write cycle (W2) are placed on the system bus 28 and the second buffer enable signal (BUF.EN2) is asserted to store the signals into the second memory 170. In addition, the first issued command is completed during BCLK 3.

In BCLK 4, the CPU 22 issues a third command. In BCLK 5, the address, data, and control signals for a third memory write cycle (W3) are placed on the system bus 28 and the first buffer enable signal (BUF.EN1) is asserted to store the signals into the first memory 169. In addition, the second command is completed in BCLK 5.

In BCLK 6, the CPU 22 issues a fourth command. In BCLK 7, the address, data, and control signals for a fourth memory write cycle (W4) are placed on the system bus 28 and the second buffer enable signal (BUF.EN2) is asserted to store the signals associated with the fourth issued command into the second memory 170. In addition, the third issued command is completed during BCLK 7.

In BCLK 8, the CPU 22 could issue a fifth command for a memory cycle, but does not in the shown example. The fourth issued command is completed in BCLK 9.

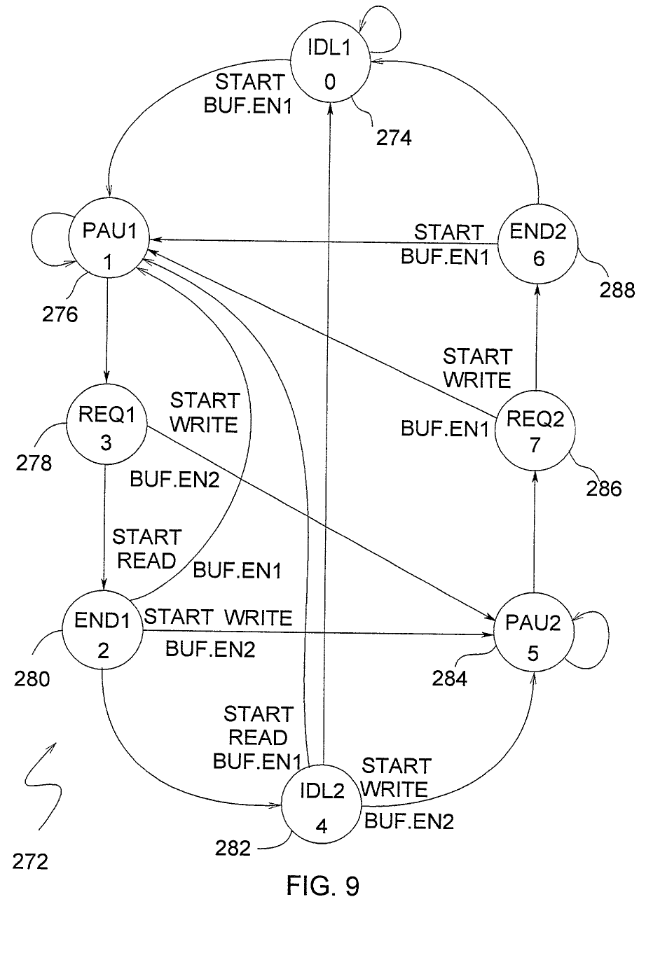

The present invention may be used in conjunction with the subject matter that is disclosed in U.S. patent application Ser. No. ______ (“High Performance Graphics Controller”), which was filed concurrently herewith (Attorney Docket No. VP027), is now pending, and is hereby incorporated in its entirety by reference. FIG. 9 illustrates that features of the High Performance Graphics Controller may be used in conjunction with the present invention. FIG. 9 presents an example of a read/write state machine 272 that can be similar to read/write state machine 172 as shown. In addition, in a state END1 280 and a state END2 288, the read/write state machine 272 checks to see whether the START signal has been asserted. If the START signal is detected for a write command, the read/write state machine 272 provides for state transitions from the state END 1 280 to a state PAU2 284, and from the state END2 288 to a state PAU1 276. Moreover, if the START signal is detected for a read command, the read/write state machine 272 provides for state transitions from the state END1 280 to the state PAU1 276, and from the state IDL2 288 to the state PAU1 276. In each shown state transition to the state PAU1 276 from another state, the signal BUF.EN1 is asserted. In addition, in each shown state transition to the state PAU2 284 from another state, the signal BUF.EN2 is asserted.

As the example in FIG. 8 shows, an advantage of the present invention is that the first issued command for a memory write cycle is completed in 3 BCLKs and subsequent commands are completed every 2 BCLKs thereafter. Another advantage of the present invention is that the read/write state machine 172 uses information provided by the signal tracker 174 to verify that a memory write command previously stored in either the first or second memories 169, 170 has been processed before a subsequent command can be stored in the same memory. If the subsequent memory write command is stored in either of the memories 169, 170 before the memory write command previously stored in the same memory is processed, the previous command will fail. The read/write state machine 172 ensures that no memory write command will fail because the subsequent command cannot be prematurely stored in the memories 169, 170.

Persons of ordinary skill in the art will readily appreciate that the read/write state machine 172 can be implemented in a number of different ways. The read/write state machine 172 is preferably implemented as a logic circuit. A read/write logic circuit may be constructed according to traditional design methods using a plurality of simple logic gates. As one skilled in the art will appreciate, the read/write logic circuit is preferably implemented by creating a source file in a hardware definition language such as VHDL or Verilog™ because the read/write logic circuit will typically require 200-300 simple logic gates. The read/write source file may by synthesized using an automated design tool to create a net list. The net list may be used by an automated layout tool to create a read/write logic circuit for implementation in a graphics controller chip or other ASIC. Alternatively, the net list may be used by a device programmer to create a fuse-map that can be used to program a PLA, PLD, or other similar programmable chip to implement the read/write logic circuit.

Moreover, while the present invention is preferably implemented in hardware, it will be understood that the read/write state machine 172 may be implemented in software as well. For example, the method of read/write state machine 172 may be embodied in a program of instructions that is stored on a medium that is read and executed by a machine to regulate the transmission of command information from a CPU to a memory controller. Any medium that can be read and executed by a machine, such as RAM, ROM, floppy disk, or fixed disk is contemplated.

The computer system 20 illustrates a preferred context for the present invention. As previously indicated, other contexts for the invention are contemplated. Any host device, such as a video decoder, an audio processor, a graphics controller, or a memory controller may be substituted for the CPU 22. Moreover, the display 26 is preferably a Liquid Crystal Display; however, the present invention may be practiced without the display 26 or with any type of video display or other output device, such as a CRT display, or a printer. Further, the CPU typically issues memory write commands to the memory 36, the registers 48, or the look-up table 50; however, other memory locations are contemplated. For example, a memory write command could be directed to a peripheral device, or an off-chip memory. Additionally, while the memory 36 is preferably synchronous random access memory (“SRAM”), any type of memory may be substituted for SRAM, such as DRAM. In addition, the system bus 28 may be replaced with separate busses for address, data, and control signals. Moreover, any alternative means for communicating address, data, and control information between the CPU 22 and the graphics controller 124 may be substituted for the system bus 28.

While the bus buffer 168 has been shown and described in a preferred embodiment having the first and second memories 169,170, the present invention is not limited to having the first and second memories 169,170. In other embodiments, the bus buffer 168 may have the capacity to store three or more commands issued by a CPU 22.

The terms and expressions that have been employed in the foregoing specification are used as terms of description and not of limitation, and are not intended to exclude equivalents of the features shown and described or portions of them. The scope of the invention is defined and limited only by the claims that follow.

What is claimed is:

1. A memory controller chip for use with an off-chip CPU issuing a plurality of commands, comprising a logic circuit coupled to a first memory and a second memory, wherein said logic circuit is adapted to respond to a first issued command from the CPU by causing the memory controller chip to store said first command in said first memory and to begin processing said first command, wherein said logic circuit is further adapted to respond to a second issued command received during said processing of said first command by storing said second command in said second memory.

2. The memory controller chip of claim 1, wherein said logic circuit is further adapted to cause the memory controller chip to begin processing said second command and to respond to a third issued command received during said processing of said second command by storing said third command in said first memory.

3. A method for regulating the transmission of command information from a CPU to a memory controller, comprising the steps of:
providing a first memory;
providing a second memory;
identifying a first command issued by the CPU;
causing the memory controller to store said first command in said first memory;
processing said first command and during said step of processing of said first command, if the CPU issues a second command, identifying said second command; and
causing the memory controller to store said second command in said second memory.

4. The method of claim 3, further comprising processing said second command and, during said step of processing of said second command, if the CPU issues a third command, causing the memory controller to store said third command in said first memory.

5. A state machine for regulating the transmission of command information from a CPU to a memory controller comprising a logic circuit and a clock for clocking the logic circuit, the logic circuit operating, at any one time, in one of a plurality of states including:
an idle state wherein the memory controller waits to receive command information and wherein, in response to the CPU having issued a first command, the logic circuit causes the first memory to store said first command;
a first pause state representing a first state transition from said idle state that occurs in response to the CPU having issued a first command; and
a first request state representing a state transition from said first pause state wherein the memory controller processes said first command, and wherein, in response to the CPU having issued a second command, the logic circuit causes the second memory to store said second command.

6. The state machine of claim 5, further comprising a second pause state representing a first state transition from said first request state, and a second request state representing a state transition from said second pause state, wherein, in said second request state, the logic circuit causes the memory controller to process said second command and, in response to the CPU issuing a third command, the logic circuit causes the first memory to store said third command.

7. A system for displaying information, the system being embodied in at least first and second chips and a graphics display device, wherein said first chip comprises a CPU for issuing a plurality of commands having associated data for display by said graphics display device, and wherein said second chip comprises:
a first command memory;
a second command memory
a data memory; and
a logic circuit for communicating with said CPU and said graphical display device and coupled to said first command memory, said second command memory, and said data memory, wherein said CPU is adapted to control the output of said graphics display device through said logic circuit, said logic circuit being adapted to respond to a first command issued by the CPU by causing said second chip to store said first command in said first command memory and to begin processing said first command, wherein said logic circuit is further adapted to respond to a second issued command received during said processing by causing said second chip to store said second command in said second command memory.

8. The system of claim 7, wherein said logic circuit is further adapted to cause said second chip to process said second command and to respond to a third issued command received during said processing of said second command by storing said third command in said first command memory.

9. A machine readable medium embodying a program of instructions executable by the machine to perform a method for regulating the transmission of command information from a CPU to a memory controller, the method of regulating comprising the steps of:
providing a first memory;
providing a second memory;
identifying a first command issued by the CPU;
causing the memory controller to store said first command in said first memory;
processing said first command and during said step of processing of said first command, if the CPU issues a second command,
identifying said second command; and
causing the memory controller to store said second command in said second memory.

10. The medium of claim 9, wherein the program of instructions is executable by the machine to perform said method further comprising processing said second command and, during said step of processing of said second command, if the CPU issues a third command, causing the memory controller to store said third command in said first memory.
